(19) United States
(12) Patent Application Publication
(10) Pub. No.: US 2011/0055482 A1
(43) Pub. Date: Mar. 3, 2011

(54) SHARED CACHE RESERVATION

(75) Inventors: Kimming So, Palo Alto, CA (US); Binh Truong, San Jose, CA (US)

(73) Assignee: Broadcom Corporation, Irvine, CA (US)

(21) Appl. No.: 12/626,448

(22) Filed: Nov. 25, 2009

Related U.S. Application Data
(60) Provisional application No. 61/237,894, filed on Aug. 28, 2009.

(51) Int. Cl. G06F 12/08; G06F 12/00

(52) U.S. Cl. 711/122; 711/130; 711/128; 711/136; 711/E12.001; 711/E12.024; 711/E12.018; 711/E12.038

(57) ABSTRACT

Various example embodiments are disclosed. According to an example embodiment, a shared cache may be configured to determine whether a word requested by one of the L1 caches is currently stored in the L2 shared cache, read the requested word from the main memory based on determining that the requested word is not currently stored in the L2 shared cache, determine whether at least one line in a way reserved for the requesting L1 cache is unused, store the requested word in the at least one line based on determining that the at least one line in the reserved way is unused, and store the requested word in a line of the L2 shared cache outside the reserved way based on determining that the at least one line in the reserved way is not unused.

### PRIORITY CLAIM

This Application claims the benefit of priority based on U.S. Provisional Patent App. No. 61/237,894, filed on Aug. 28, 2009, entitled, “Shared Cache Reservation,” the disclosure of which is hereby incorporated by reference.

### TECHNICAL FIELD

This description relates to memory hierarchies in computer systems.

### BACKGROUND

In a computing system, memory may be organized in a hierarchy. At the top of the hierarchy, registers provide very fast data access to a processor, but very little storage capacity. Multiple levels of cache may offer further tradeoffs between access speed and storage capacity. Main memory may provide a large storage capacity but slower access than either the registers or any of the cache levels.

### SUMMARY

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a computer system according to an example embodiment.

FIG. 2 is a block diagram of a level-2 shared cache and bus/interconnect included in the computer system according to an example embodiment.

FIG. 3 is a block diagram of a reservation control register according to an example embodiment.

FIG. 4 is a block diagram of a reservation indicator register according to an example embodiment.

FIG. 5 is a block diagram of a line included in the level-2 shared cache according to an example embodiment.

FIG. 6 is a flowchart of an algorithm performed by the computer system according to an example embodiment.

FIG. 7 is a flowchart of an algorithm performed by the computer system according to another example embodiment.

FIG. 8 is a flowchart showing a method according to an example embodiment.

### DETAILED DESCRIPTION

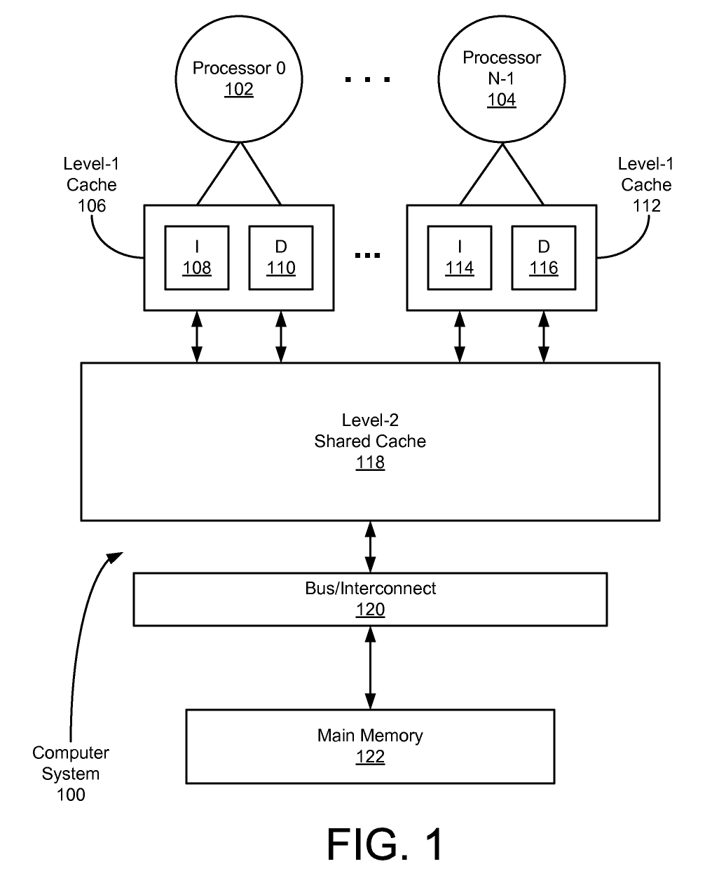

FIG. 1 is a block diagram of a computer system 100 according to an example embodiment. The computer system 100 may, for example, include a desktop computer, notebook computer, personal digital assistant (PDA), server, or embedded system, such as a set-top box or network card, according to example embodiments. The computer system 100 may, for example, receive and execute instructions in conjunction with data received via one or more input devices (not shown), and may display results of the executed instructions via one or more output devices (not shown).

The computing system 100 may include any number (such as N) of processors 102, 104. While two processors 102, 104 are shown in FIG. 1, any number or plurality of processors 102, 204 may be included in the computing system 100, according to various example embodiments. Each of the processors 102, 104 may, for example, read and write data to and from memory, add numbers, test numbers, and/or signal input or output devices to activate.

The computing system 100 may include a memory hierarchy. According to an example memory hierarchy, the computing system 100 may use multiple levels of memories. As the distance of a memory unit from the processor 102, 104 increases, the size or storage capacity and the access time may both increase. The computing system 100 may seek to store instructions or data which are more frequently used at the highest levels of the memory which are closer to the processor 102, 104. In example embodiment, the processors 102, 104 may read or write instructions and/or data from or to the highest levels of memory which are closest to the processors 102, 104; instructions and/or data may be written or copied between two adjacent memory levels at a time.

In the example shown in FIG. 1, each of the N processors 102, 104 may be associated with a level 1 (or L1) cache 106, 112. While two L1 caches 106, 112 are shown in the example embodiment of FIG. 1, any number of L1 caches 106, 112 corresponding to the number N of processors 102, 104 may be included in the computing system 100. The L1 caches 106, 112 may include small, fast memories, and may act as buffers for slower, larger memories. The L1 caches 106, 112 may be at the top of the memory hierarchy and/or closest to their respective processors 102, 104. The L1 caches 106, 112 may each be dedicated to their respective processor 102, and/or may be accessible only by their respective processors 102, 104 (and to lower memory levels). The L1 caches 106, 112 may use any memory technology with a relatively low access time, such as static random access memory (SRAM), as a non-limiting example.

In the example shown in FIG. 1, each of the L1 caches 106, 112 may include a split cache scheme. According to an example split cache scheme, each of the L1 caches 106, 112 may include an instruction cache 108, 114 and a data cache 110, 116. The instruction cache 108, 114 and data cache 110, 116 of each L1 cache 106, 112 may be independent of each other and operate in parallel with each other. The instruction cache 108, 114 may handle instructions, and the data cache 110, 116 may handle data. While the L1 caches 106, 112 shown in the example embodiment of FIG. 1 include the split cache scheme, other example embodiments may not include the split cache scheme.

In the example embodiment shown in FIG. 1, the computing system 100 may also include a level-2 (L2) shared cache 118. The L2 red cache 118 may be lower in the memory hierarchy and/or farther from the processors 102, 104 than the L1 caches 106, 112. The L2 shared cache 118 may use any memory technology with a relatively low access time, such as SRAM, as a non-limiting example. The L2 shared cache 118 may, for example, have a larger storage capacity, but also a higher access time, than the L1 caches 106, 112.

The L2 shared cache 118 may be shared by the N processors 102, 104 and/or their associated L1 caches 106, 112. The N processors 102, 104 may share the L2 shared cache 118 by each writing data to and/or reading data from the L2 shared cache 118 (via their respective L1 caches 106, 112). The processors 102, 104 may access the L2 shared cache 118 (via their respective L1 caches 106, 112) when the processor 102, 104 “misses” at its respective L1 cache 106, 112, such as by attempting to read, access, or retrieve data which is not stored in its respective L1 cache 106, 112. The processors 102, 104 may miss at their respective L1 caches 106, 112 due to multiprocessor interfacing issues, instruction cache 108, 114 and/or data cache 110, 116 misses, different processes utilizing the respective L1 cache 106, 112 (such as processes using virtual memory identifiers or address space identifiers), or user and/or kernel modes, as non-limiting examples.

Sharing the L2 shared cache 118 between the N processors 102, 104 may provide an advantage of high utilization of available storage in situations in which not all of the processors 102, 104 need to access the L2 shared cache 118, or in which not all of the processors 102, 104 need to use a large portion of the L2 shared cache 118 at the same time. However, if there are no regulations on sharing the L2 shared cache 118 by the processors 102, 104, then if one processor 102, 104 uses a large portion of the L2 shared cache's 118 storage capacity, other processor(s) may suffer from performance losses when their respective cache line(s) are pushed out of the L2 shared cache 118 by the processor 102, 104 which is using a large portion of the L2 shared cache's 118 storage capacity.

In an example embodiment, the computing system 100 may utilize an L1/L2 inclusion scheme, in which any data stored in any of the L1 caches 106, 112 is also stored in the L2 shared cache 118. To maintain the L1/L2 inclusion scheme, if a line of data currently resides in at least one of the L1 caches 106, 112 and in the L2 shared cache 118, then if the line in the L2 shared cache is replaced, then the corresponding line in the 118 L1 cache 106, 112 must also be replaced. If a line in at least one of the L1 caches 106, 112 replaced, and the line of data also currently residing in the L2 shared cache 118 is, then the line in the shared L2 cache may not also need to be replaced, according to an example embodiment.

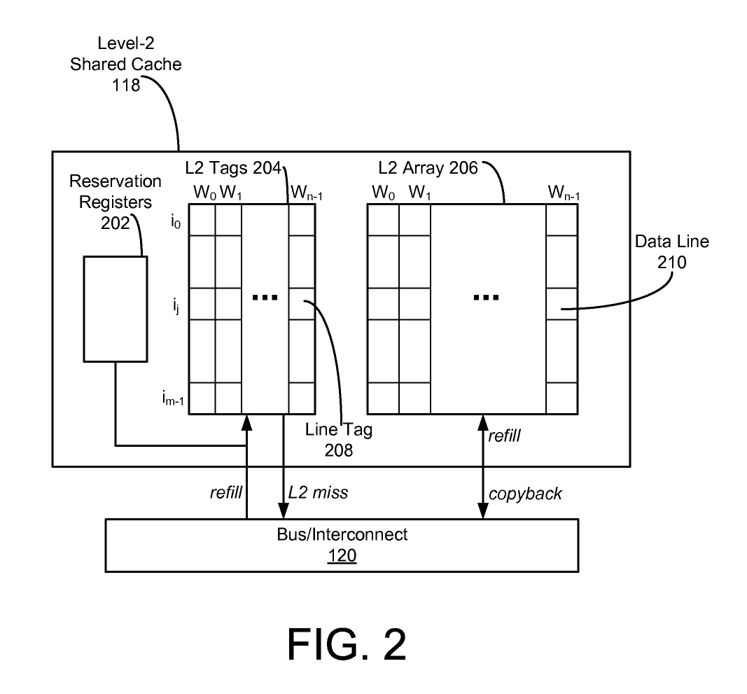

In an example embodiment, guaranteeing a minimum amount of cache space for certain types of requests, or for some or all of the processors 102, 104, may provide more predictable or stable performance for the computer system 100. In an example embodiment, the L2 shared cache may utilize set associativity, in which there may be a fixed number of locations in the L2 shared cache 118 where each block or line or data may be stored. The L2 shared cache 118 may utilize n-way set associativity, there will be n possible locations for a given line or block of data (n as used in relation to set associativity need not be the same as N as used in the number of processors 102, 104). The shared L2 cache may, for example, have a set associativity of two (2-way), four (4-way, or any larger number for n, according to example embodiments. With n-way set associativity, the L2 shared cache 118 may be address mapped such that part of an address of a memory access may be used to index one set, which may be denoted iⱼ, of lines in the L2 shared cache 118, and the L2 shared cache 118 may compare the address to all of the line tags in the set of n lines to determine a hit or a miss at the L2 shared cache 118. The L2 shared cache 118 is discussed further below with reference to FIG. 2.

The computer system 100 may also include a bus/interconnect 120. The bus/interconnect 120 may serve as an interface for devices within the computer system 100, and/or may route data between devices within the computer system 100. For example, the L2 shared cache 118 may be coupled to a main memory 122 via the bus/interconnect 120. The main memory 122 may, for example, hold data and programs while the programs and/or processes are running. The main memory 122 (or primary memory) may, for example, include volatile memory, such as dynamic random access memory (DRAM). While not shown in FIG. 1, the main memory 122 may be coupled to a secondary memory, which may include nonvolatile storage such as a magnetic disk or flash memory.

FIG. 2 is a block diagram of the L2 shared cache 118 and bus/interconnect 120 included in the computer system 100 according to an example embodiment. In an example embodiment, portions of the L2 shared cache 118 may be reserved to specified processors 102, 104 on a “way” basis. In this example, the L2 shared cache 118 may include n ways, based on the n-way set associativity utilized by the L2 shared cache 118.

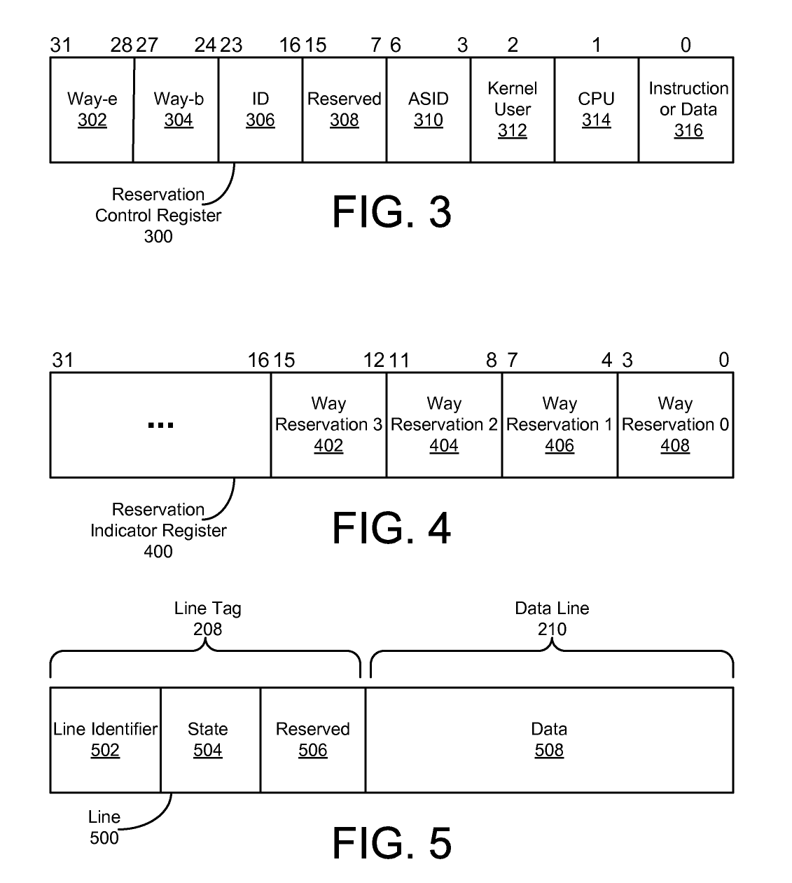

The L2 shared cache 118 may include a table of L2 tags 204, which includes line tags 208 used to identify the addresses of lines of data stored in the L2 shared cache 118, and an L2 array 206, which includes data lines 210 that store the actual data. Each of the n ways may be divided into a set iⱼ with m lines or blocks; the number m of lines or blocks included in each set i equals the total number of lines 208, 210 stored in the L2 shared cache 118 divided by the number n of ways. The L2 shared cache 118 may also include reservation registers 202, which may be used to reserve the ways. The reservation registers 202 may include n reservation control registers, described below with reference to FIG. 3, and a reservation indicator register, described below with reference to FIG. 4, according to an example embodiment. These registers may be programmed by the software at any time to the desired reservation.

FIG. 3 is a block diagram of a reservation control register 300 according to an example embodiment. The reservation control register 300 may, for example, be included in a processor which controls the L2 shared cache 118. The reservation control register 300 may be programmed, such as at run time, to enable or disable a reservation. The reservation control register 300 may be programmed, for example, based on expected memory needs of the processors 102, 104. In an example embodiment, one reservation control register 300 may be associated with each way, and may indicate whether the way is reserved, and if the way is reserved, to which processor 102, 104 and/or L1 cache 106, 112 the way is reserved.

In the example shown in FIG. 3, which processes thirty-two bit words, the numbers 0 through 31 indicate which bits of the reservation control register 300 are allocated to particular fields. For example, bit zero may be an instruction or data field 316, which may indicate whether the reserved way will be reserved for instructions or data. Bit 1 may be a CPU field 314 or processor field, and may identify the processor 102, 104 for which the way is reserved. In example embodiments in which the computer system 100 includes more than two processors 102, 104, the CPU field 314 may include more than one bit. Bit 2 may be a kernel user field 312 which may identify whether the way is reserved to the user of the respective processor 102, 104 or to the kernel running on the respective processor 102, 104. Bits 3-6 may be an address space identifier (ASID) field 310, sometimes called a Process ID or Job ID, which may identify an address space in the L2 shared cache 118 reserved by the reservation control register 300. Bits 7-15 may be reserved 308, or may be used for purposes determined by a programmer. Bits 16-23 may be an identifier field 306, which may indicate whether the identified ways are reserved and/or whether the identified ways are currently storing data. Bits 24-27 may be a first way reserved register 304, and may indicate a first reserved way controlled by the reservation control register 300. Bits 28-31 may be a last way reserved register 302, and may indicate a last reserved way controlled by the reservation control register 300. The first way reserved register 304 and last way reserved register 302 may, by indicating the first and last reserved ways, indicate all of the reserved ways controlled by the reservation control register 300. While the reservation control register 300 has been described with respect to specific bits and fields, other bits and fields may be used to indicate the status and purpose of reserved ways, according to example embodiments.

FIG. 4 is a block diagram of a reservation indicator register 400 according to an example embodiment which processes thirty-two bit words. The reservation indicator register 400 may indicate whether one or more ways in the L2 shared cache 118 are reserved, and/or whether the reserved ways in the L2 shared cache 118 are storing data for the processor 102, 104 and/or L1 cache 106, 112 for which the respective ways are reserved. The reservation indicator register 400 may, for example, include one way reservation field 402, 404, 406, 408 associated with each reserved way indicated by the reservation control register(s) 300. Each of the way reservation fields 402, 404, 406, 408 may indicate whether its respective way is reserved and/or whether its respective way is currently storing data for its respective processor 102, 104 and/or L1 cache 106, 112. The L2 shared cache 118 may update the way reservation fields 402, 404, 406, 408 when data is stored or removed from the reserved ways, and the L2 shared cache 118 may check the way reservation fields 402, 404, 406, 408 to determine whether the ways are reserved and/or storing data for their respective processors 102, 104, and/or L1 caches 106, 112. The L2 shared cache 118 may include a processor (not shown) which performs the updates and/or checks, according to an example embodiment.

FIG. 5 is a block diagram of a line 500 included in the L2 shared cache 118 according to an example embodiment. The line 500 may, for example, include the line tag 208 included in the L2 tags 204 shown in FIG. 2, and/or the data line 210 included in the L2 array 206 shown in FIG. 2. In this example, the line tag 208 may include a line identifier field 502. The line identifier field 502 may, in combination with an index of a cache block, specify a memory address of the word or data contained in the line 500. For example, a combination of the index iⱼ and the number stored in the line identifier field 502 may specify the address in main memory 122 which stores the word or data contained in the line 500.

The line tag 208 may also include a state field 504. The state field 504 may indicate whether any data is stored in the line 500. The state field 504 may also indicate how recently the line 500 has been accessed or used (written to or read from); the L2 shared cache 118 may determine which line 500 to write over using least recently used (LRU) or most recently used (MRU) algorithms by checking the state fields 504 of tags 208 in a set, according to an example embodiment.

The line tag 208 may also include a reserved field 506. The reserved field 506 may indicate whether the line 500 is reserved to a processor 102, 104 and/or to an L1 cache 106, 112, and/or the reserved field 506 may indicate whether the line 500 has been accessed by the processor 102, 104 and/or by the L1 cache 106, 112 for which the line 500 is reserved. In an example embodiment, a processor 102, 104 and/or L1 cache 106, 112 may first access or write to the lines in the way of the L2 shared cache 118 which are reserved to the respective processor 102, 104 and/or associated L1 cache 106, 112, and may access or write to other lines 500 in the L2 shared cache 118 after accessing or writing to the lines in the way of the L2 shared cache 118 which are reserved to the respective processor 102, 104 and/or associated L1 cache 106, 112. The processor 102, 104 and/or associated L1 cache 106, 112 may access lines 500 and/or ways reserved to other processors 102, 104 and/or associated L1 caches 106, 112 only if the lines 500 and/or ways have not already been accessed or written to by the processors 102, 104 and/or associated L1 caches 106, 112 for which the lines 500 and/or ways are reserved.

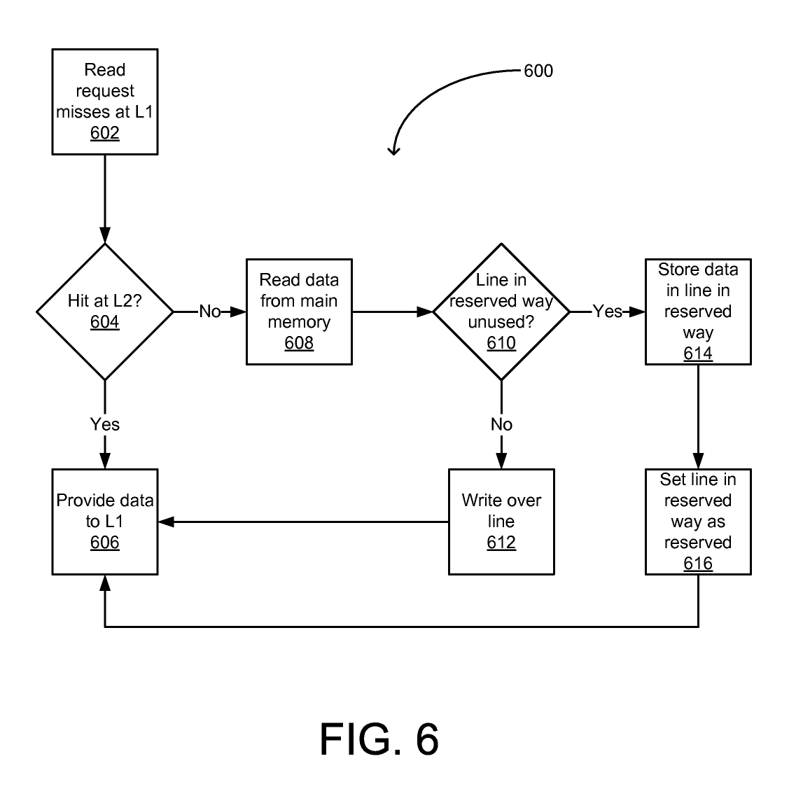

FIG. 6 is a flowchart of an algorithm 600 performed by the computer system 100 according to an example embodiment. In this example, the processor 102, 104 may send a read request to its respective L1 cache 106, 112. The read request may “miss” at the L1 cache 106, 112 (602) because the requested data or word, identified by, associated with, and/or stored in an address in main memory 122, is not currently stored in the L1 cache 106, 112. The requested data or word may not be currently stored in the L1 cache 106, 112 because the processor 102, 104 has not yet accessed, read, or written the requested data or word, or because the L1 cache 106, 112 has accessed or written over the requested data or word with another data or word identified by, associated with, and/or stored in a different address in main memory 122, according to example embodiments.

Based on the read request missing at the L1 cache 106, 112, the computer system 100 and/or L2 shared cache 118 may determine whether the read request “hits” at the L2 shared cache 118 (604). The read request may be considered to “hit” at the L2 shared cache 118 if the requested data or word identified by, associated with, and/or stored in an address in main memory 122, is currently stored in the L2 shared cache 118. The requested data or word may be currently stored in the L2 shared cache 118 based on the processor 102, 104 previously accessing, reading, or writing the requested data or word, and the requested data or word not being written over by another data or word identified by, associated with, and/or stored in a different address in main memory 122, according to an example embodiment. If the read request does hit at the L2 shared cache 118, then the L2 shared cache 118 may provide the requested data or word to the L1 cache 106, 112 (606), and the L1 cache 106, 112 may provide the requested data or word to its respective processor 102, 104.

If the read request does not hit at the L2 shared cache 118, then the L2 shared cache 118 may read the requested data or word from main memory 122 (608). The L2 shared cache 118 may also determine where in the L2 shared cache 118 to store the requested data or word. In an example embodiment, the L2 shared cache 118 may determine if there is an unused line in a way which is reserved to the L1 cache 106, 112 (and/or its associated processor 102, 104) that sent the read request (610). The L2 shared cache 118 may determine whether the L1 cache 106, 112 (and/or its associated processor 102, 104) that sent the read request has any unused or empty lines in its reserved way(s) (610). The L2 shared cache 118 may, for example, determine whether the L1 cache 106, 112 (and/or its associated processor 102, 104) that sent the read request has any unused or empty lines in its reserved way(s) (610) by checking the state fields 504 and/or reserved fields 506 of the line tags 208 of the lines 500 in the ways indicated by the reservation control register 300 and/or reservation indicator register 400 as being reserved for the requesting L1 cache 106, 112 (and/or its associated processor 102, 104).

If the L2 shared cache 118 determines that the requesting L1 cache 106, 112 (and/or its associated processor 102, 104) does not have any unused lines 500 in its reserved way(s), then the L2 shared cache 118 may write the requested data or word over a least recently used (LRU) line in the L2 shared cache 118 (612) which is in the set associated with the requested data or word's location in main memory 122, according to an example embodiment. In other example embodiments, the L2 shared cache 118 may write over a most recently used (MRU) line in the L2 shared cache 118 which is in the set associated with the requested data or word's location in main memory 122, or may write the requested data or word over a randomly determined line in the L2 shared cache 118 which is in the set associated with the requested data or word's location in main memory 122. While the term, “write over,” is used in this paragraph, the line in the L2 shared cache 118 which is written over may or may not have previously stored a data or word. After writing over the line in the L2 shared cache 118, the L2 shared cache 118 may provide and/or send the requested data or word to the L2 cache 106, 112 (606); the L1 cache may provide and/or send the requested data and/or word to its associated processor 102, 104, according to an example embodiment.

If the L2 shared cache 118 determines that the requesting L1 cache 106, 112 (and/or its associated processor 102, 104) does have an unused line 500 in its reserved way(s), then the L2 shared cache 118 may write over an unused line 500 in its reserved way(s) (614). The L2 shared cache 118 may also set the written line 500 as reserved (616). The L2 shared cache 118 may, for example, set the written line 500 as reserved (616) by setting the reserved field 506 of the line tag 208 to indicate that the line 500 is storing data or a word for the L1 cache 106, 112 (and/or its associated processor 102, 104) for which the line 500 is reserved. The L2 shared cache 118 may also set the state field 504 of the line tag 208 to indicate that the line 500 is storing data or a word; the L2 shared cache 118 may also set the state field 504 of the line tag 208 to indicate when the line 500 accessed the data or word, which may be used to assist in a least recently used (LRU) or most recently used (MRU) algorithm, according to example embodiments. The L2 shared cache 118 may also provide the requested data or word to the requesting L1 cache 106, 112 (606). The requesting L1 cache 106, 112 may provide the requested data or word to its associated processor 102, 104, according to an example embodiment.

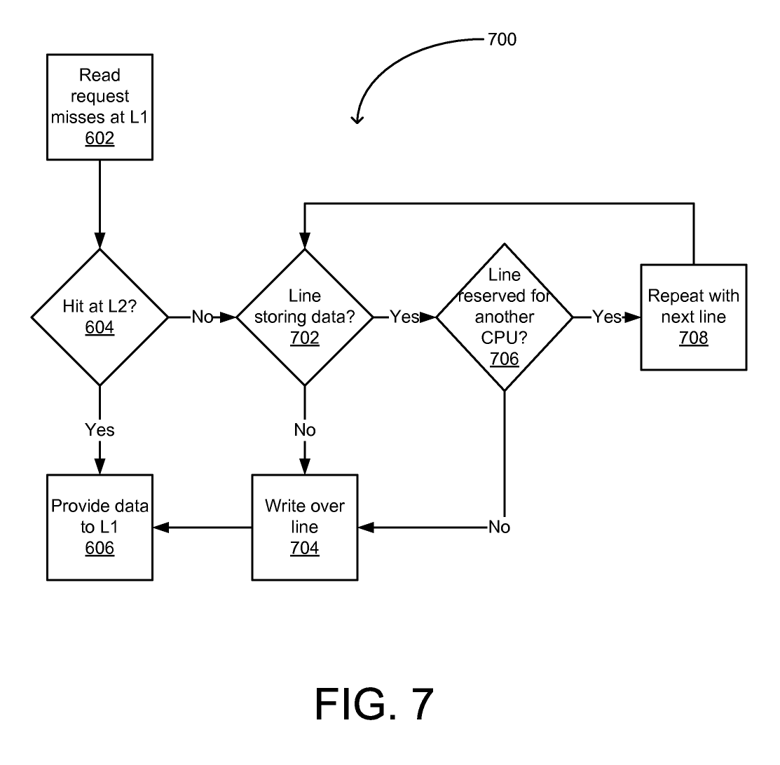

FIG. 7 is a flowchart of an algorithm 700 performed by the computer system 100 according to another example embodiment. In this example, the processor 102, 104 may send a read request which misses as its associated L1 cache 106, 112 (602), as described above with reference to FIG. 6. Based on the read request missing at the L1 cache 106, 112, the computer system 100 and/or L2 shared cache 118 may determine whether the read request hits at the L2 shared cache 118 (604), also as described above with reference to FIG. 6. If the read request does hit at the L2 shared cache 118, then the L2 shared cache 118 may provide the requested data or word to the L1 cache 106, 112 (606), and the L1 cache 106, 112 may provide the requested data or word to its respective processor 102, 104, also as described above with reference to FIG. 6.

If the read request does not hit at the L2 shared cache 118, then the computer system 100 and/or the L2 shared cache 118 may read the requested data or word from main memory 122. After reading the requested data or word from main memory 122, the L2 shared cache 118 may determine where in the L2 shared cache 118 to store the requested data or word. The computer system 100 and/or L2 shared cache 118 may, for example, determine whether a selected line 500 in the L2 shared cache 118 is currently storing any data or word, or whether the selected line 500 is empty (702). The selected line 500 may, for example, be a least recently used (LRU) line 500 which is in the set associated with the requested data or word's location in main memory 122, a most recently used (MRU) line 500 which is in the set associated with the requested data or word's location in main memory 122, or a randomly selected line 500 which is in the set associated with the requested data or word's location in main memory 122, according to example embodiments. The LRU line 500 or the MRU line 500 may be determined by checking the state field 504 of the tags 208 of the lines 500 in the set associated with the requested data or word's location in main memory 122, according to an example embodiment.

If the computer system 100 and/or the L2 shared cache 118 determines that the selected line 500, which may be the LRU line 500, the MRU line 500, or a randomly selected line 500, is not currently storing data or a word, then the computer system 100 and/or the L2 shared cache 118 may write the requested data or word into the selected line 500 (704). The computer system 100 and/or the L2 shared cache 118 may also record the act of storing the data or word in the selected line 500, such as by updating the line tag 208 of the selected line 500. If the line to be replaced and/or stored has the reserved line, field, or bit 506 set to zero (0), and the computer system 100 and/or the L2 shared cache 118 indicates that the processor 102 has reserved the way in the reservation indicator register 400, then the computer system 100, processor 102, 104, and/or L2 shared cache 118 may turn on the reserved line, field, or bit 506. The L2 shared cache 118 may provide the requested data or word to the L1 cache 106, 112 (606), which may provide the data or word to its associated processor 102, 104, according to an example embodiment.

If the computer system 100 and/or the L2 shared cache 118 determines that the selected line 500 is currently storing data or a word, then the computer system 100 and/or the L2 shared cache 118 may determine whether the selected line 500 is reserved for a processor 102, 104 and/or L1 cache 106, 112 other than the processor 102, 104 and/or L1 cache 106, 112 which made the read request (706). The computer system 100 and/or the L2 shared cache 118 may determine whether the selected line 500 is reserved for another processor 102, 104 and/or L1 cache 106, 112 by, for example, checking the reservation control register 300 and/or reservation indicator register 400 for the way which included the selected line 500. If the reserved line, field, or bit 506 is set to one (1), but the reservation indicator register 400 indicates that the way is not reserved, then after the line is refilled, the computer system 100, processor 102, 104, and/or L2 shared cache 118 may set the reserved line, field, or bit 506 to zero (0).

If the computer system 100 and/or the L2 shared cache 118 determines that the selected line 500 is not reserved for another processor 102, 104 and/or L1 cache 106, 112, then the L2 shared cache 118 may write over the selected line 500 (704). If the computer system 100 and/or the L2 shared cache 118 determines that the selected line 500 is reserved for another processor 102, 104 and/or L1 cache, then the computer system 100 and/or L2 shared cache 118 may select another line, such as the next least recently used line 500, the next most recently used line 500, or another randomly selected line 500, and repeat the actions (708) of determining whether the selected line 500 is storing data (702) and/or determining whether the selected line 500 is reserved for another processor 102, 104 and/or L1 cache 106, 112 (706), according to an example embodiment.

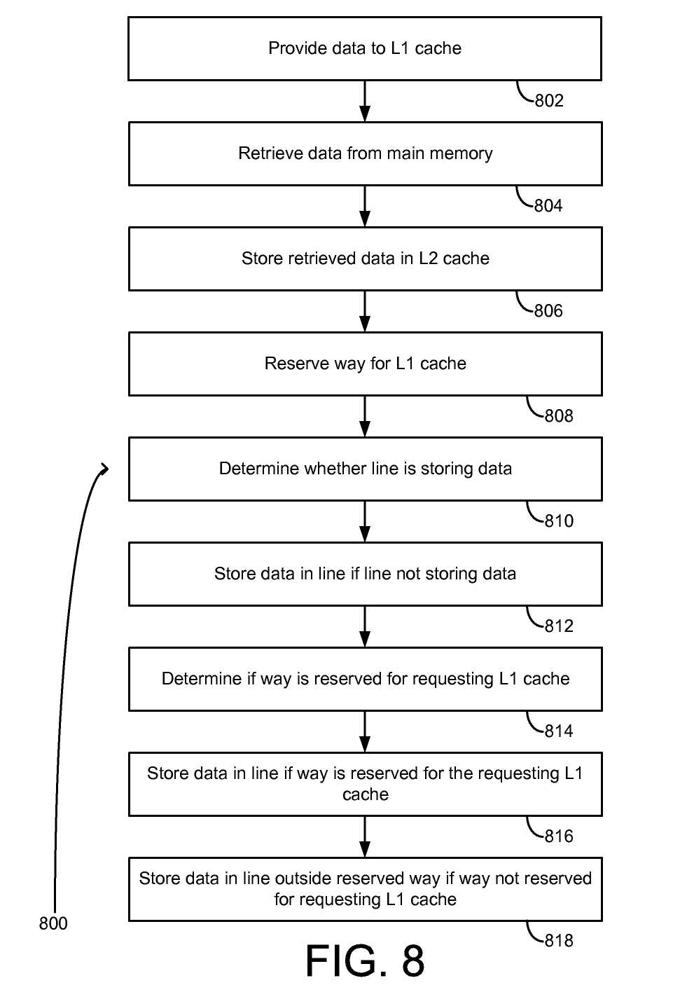

FIG. 8 is a flowchart showing a method 800 according to an example embodiment. In an example embodiment, the shared L2 cache 118 may provide data to each of a plurality of L1 caches 106, 112 in response to receiving a read request from the respective L1 cache 106, 112 (802). The shared L2 cache 118 may retrieve the data from a main memory 122 in response to receiving the read request if the data was not stored in the L2 shared cache 118 at the time of receiving the read request from the respective L1 cache 106, 112 (804). The shared L2 cache 118 may store the data retrieved from the main memory 122 in the L2 shared cache 118 according to an n-way associativity scheme with n ways, n being an integer greater than one (806). The shared L2 cache 118 may reserve at least one of the n ways for one of the L1 caches (808). The shared L2 cache 118 may determine whether a line in the reserved way is currently storing data (810). The shared L2 cache 118 may store the data retrieved from the main memory 122 in a line of the reserved way based on determining that the line of the reserved way is not currently storing data (812). The shared L2 cache 118 may determine whether the reserved way is reserved for the requesting L1 cache (814). The shared L2 cache 118 may store the data retrieved from the main memory 122 in the line of the reserved way based on determining that the reserved way is reserved for the requesting L1 cache (816). The shared L2 cache 118 may store the data in a line outside the reserved way based on determining that the reserved way is not reserved for the requesting L1 cache (818).

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device for execution by, or to control the operation of, data processing apparatus, e.g., a programmable processor, a computer, or multiple computers. A computer program can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A computer system comprising:
a plurality of level-one (L1) caches, each of the plurality of L1 caches being coupled to a level-2 (L2) shared cache;
the L2 shared cache coupled to each of the plurality of L1 caches and to a main memory, the shared cache being configured to:
determine whether a word requested by one of the L1 caches is currently stored in the L2 shared cache;
read the requested word from the main memory based on determining that the requested word is not currently stored in the L2 shared cache;
determine whether at least one line in a way reserved for the requesting L1 cache is unused;
store the requested word in the at least one line based on determining that the at least one line in the reserved way is unused; and
store the requested word in a line of the L2 shared cache outside the reserved way based on determining that the at least one line in the reserved way is not unused; and
the main memory coupled to the L2 shared cache.

2. The computer system of claim 1, wherein the L2 shared cache is configured to store the requested word in a least recently used (LRU) line of the L2 shared cache outside the reserved way based on determining that the at least one line in the reserved way is not unused.

3. The computer system of claim 1, wherein the L2 shared cache is configured to store the requested word in a most recently used (MRU) line of the L2 shared cache outside the reserved way based on determining that the at least one line in the reserved way is not unused.

4. The computer system of claim 1, wherein the L2 shared cache is configured to store the requested word in a randomly selected line of the L2 shared cache outside the reserved way based on determining that the at least one line in the reserved way is not unused.

5. The computer system of claim 1, wherein the L2 shared cache is configured to store data read from the main memory according to an n-way associativity scheme with n ways, n being an integer greater than one.

6. The computer system of claim 1, wherein the L2 shared cache is configured to store data read from the main memory according to an n-way associativity scheme with n ways, n being an integer greater than one, the n-way associativity scheme allowing the requested word to be stored in a set with n memory locations based on a main memory address associated with the requested word.

7. The computer system of claim 1, wherein the L2 shared cache is configured to:
store data read from the main memory according to an n-way associativity scheme with n ways, n being an integer greater than one; and
reserve at least one of the n ways for the requesting L1 cache.

8. The computer system of claim 1, wherein the L2 shared cache is configured to provide the requested word to the requesting L1 cache.

9. The computer system of claim 1, further comprising a plurality of processors, each of the plurality of processors being coupled to one of the plurality of L1 caches, each of the processors being configured to:
process data;
read data from the L1 cache to which the respective processor is coupled; and
write data to the L1 cache to which the respective processor is coupled.

10. The computer system of claim 1, further comprising a plurality of processors, each of the plurality of processors being coupled to one of the plurality of L1 caches, each of the processors being configured to:
process data;
read data from the L1 cache to which the respective processor is coupled; and
write data to the L1 cache to which the respective processor is coupled, wherein each of the plurality of L1 caches includes an instruction cache coupled to its respective processor and a data cache coupled to its respective processor.

11. The computer system of claim 1, wherein the computing system is configured to implement an inclusion scheme in which all data stored in any of the L1 caches must also be stored in the L2 shared cache.

12. The computer system of claim 1, wherein the computing system is configured to implement an inclusion scheme in which any data written over in the L2 shared cache must also be written over the L1 cache(s) in which the data were stored.

13. The computer system of claim 1, wherein each of the L1 caches has a lower storage capacity and a faster access time than the L2 shared cache.

14. A computer system comprising:
a plurality of level-one (L1) caches, each of the plurality of L1 caches being coupled to a level-2 (L2) shared cache;
the L2 shared cache coupled to each of the plurality of L1 caches and to a main memory, the shared cache being configured to:
determine whether a word requested by one of the L1 caches is currently stored in the L2 shared cache;
read the requested word from the main memory based on determining that the requested word is not currently stored in the L2 shared cache;
select a line in the L2 shared cache in which to store the requested word;
determine whether the selected line is currently storing data;
write the requested word in the selected line if the selected line is not currently storing data;
determine whether the selected line is reserved for an L1 cache other than the requesting L1 cache based on determining that the selected line is currently storing data;
write the requested word over the selected line based on determining that the selected line is not reserved for an L1 cache other than the requesting L1 cache; and
select another line in the L2 shared cache in which to store the requested word based on determining that the selected line is reserved for the L1 cache other than the requesting L1 cache; and
the main memory coupled to the L2 shared cache.

15. The computer system of claim 14, wherein the L2 shared cache is configured to:
select a least recently used (LRU) line in the L2 shared cache in which to store the requested word; and
select a next least recently used line in the L2 shared cache in which to store the requested word based on determining that the selected LRU line is reserved for the L1 cache other than the requesting L1 cache.

16. The computer system of claim 14, wherein the L2 shared cache is configured to:
select a most recently used (MRU) line in the L2 shared cache in which to store the requested word; and
select a next most recently used line in the L2 shared cache in which to store the requested word based on determining that the selected MRU line is reserved for the L1 cache other than the requesting L1 cache.

17. The computer system of claim 14, wherein the L2 shared cache is configured to:
randomly select a line in the L2 shared cache in which to store the requested word; and
randomly select another line in the L2 shared cache in which to store the requested word based on determining that the randomly selected line is reserved for the L1 cache other than the requesting L1 cache.

18. The computer system of claim 14, wherein the L2 shared cache is configured to repeat selecting another line in the L2 shared cache in which to store the requested word until either:
determining that the selected another line is not currently storing data; or
determining that the selected another line is not reserved for an L1 cache other than the requesting L1 cache.

19. The computer system of claim 14, wherein the computing system is configured to implement an inclusion scheme in which all data stored in any of the L1 caches must also be stored in the L2 shared cache.

20. A computer system comprising:
a plurality of level-one (L1) caches, each of the plurality of L1 caches being coupled to a level-two (L2) shared cache;
the L2 shared cache coupled to each of the plurality of L1 caches and to a main memory, the shared cache being configured to:
provide data to each of the plurality of L1 caches in response to receiving a read request from the respective L1 cache;
retrieve the data from the main memory in response to receiving the read request if the data was not stored in the L2 shared cache at the time of receiving the read request from the respective L1 cache;
store the data retrieved from the main memory in the L2 shared cache according to an n-way associativity scheme with n ways, n being an integer greater than one;
reserve at least one of the n ways for one of the L1 caches;
determine whether a line in the reserved way is currently storing data;
store the data retrieved from the main memory in a line of the reserved way based on determining that the line of the reserved way is not currently storing data;
determine whether the reserved way is reserved for the requesting L1 cache;
store the data retrieved from the main memory in the line of the reserved way based on determining that the reserved way is reserved for the requesting L1 cache; and
store the data in a line outside the reserved way based on determining that the reserved way is not reserved for the requesting L1 cache; and
the main memory coupled to the level-two shared cache.
